(19) United States
(12) Patent Application Publication
(10) Pub. No.: US 2025/0100088 A1
(43) Pub. Date: Mar. 27, 2025

(54) SOLDER MATERIAL, LAYER STRUCTURE, AND METHOD OF FORMING A LAYER STRUCTURE

(71) Applicant: Infineon Technologies AG, Neubiberg (DE)

(72) Inventors: Alexander HEINRICH, Bad Abbach (DE); Verena MUHR, Regensburg (DE); Konrad RÖSL, Teublitz (DE); Maximilian SIMMANN, Sinzing (DE); Catharina WILLE, Regensburg (DE)

(73) Assignee: Infineon Technologies AG, Neubiberg (DE)

(21) Appl. No.: 18/774,056

(22) Filed: Jul. 16, 2024

(30) Foreign Application Priority Data
Jul. 17, 2023 (DE) 10 2023 118 849.6

(51) Int. Cl. B23K 35/36; B23K 35/02

(52) U.S. Cl. CPC B23K 35/3618; B23K 35/025

(57) ABSTRACT

A solder material is provided. In one or more examples, the solder material may include metal solder particles, a carboxylic acid, and an alcohol selected from the group consisting of methanol, ethanol, propan-1-ol, propan-2-ol, 2-methyl-1-propanol, butan-1-ol, pentan-1-ol, 1,2-propanediol, 1,3-propanediol, and glycerol.

### CROSS-REFERENCE TO RELATED APPLICATION

This Utility patent application claims priority to German Patent Application No. 10 2023 118 849.6 filed Jul. 17, 2023, which is incorporated herein by reference.

### TECHNICAL FIELD

Various embodiments relate generally to a solder material, a layer structure, a method of forming a solder material, and to a method of forming a layer structure.

### BACKGROUND

As of today, soldering pastes contain a complex mixture of chemicals (typically referred to as “flux system”) that may provide a liquid component to make a metal particle mixture dispensable, and furthermore several other components like thickener, activators and tensides for various other purposes.

### SUMMARY

A solder material is provided. The solder material may include metal solder particles, a carboxylic acid, and an alcohol selected from the group consisting of methanol, ethanol, propan-1-ol, propan-2-ol, 2-methyl-1-propanol, butan-1-ol, pentan-1-ol, 1,2-propanediol, 1,3-propanediol, and glycerol.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of a solder material in accordance with various embodiments and visualizes its reaction to the soldering process;

FIG. 2 shows a schematic illustration of a solder material in accordance with various embodiments and visualizes its reaction to the soldering process;

FIG. 3A shows a schematic illustration of a method of forming a layer structure in accordance with various embodiments, and FIG. 3B shows a schematic illustration of a layer structure resulting from applying the method shown in FIG. 3A or from using a solder material in accordance with various embodiments for forming the layer structure;

FIG. 4 shows a flow diagram of a method of forming a layer structure in accordance with various embodiments; and

FIG. 5 shows a flow diagram of a method of forming a layer structure in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

A basic approach of various embodiments may be to use, as the solder material, metal particles only, and to activate the surfaces of the metal particles with a reducing agent (e. g., immediately) prior to a melting of the low-melting component.

This approach may be served by providing only the metal solder particles (or, alternatively, by mixing the metal solder particles with a volatile, non-reactive liquid to make the powder mixture easier to handle), apply the metal solder particles (or the mixture, respectively), and solder it using a reducing (e.g. formic acid) atmosphere.

To avoid the need for a furnace that is capable of providing a reducing (e. g., formic acid) atmosphere, another approach may alternatively be pursued:

In various embodiments, a solder material is provided that may consist only of a metal powder (for example, a mixture of Ni particles and Sn particles) and a reducing tacking agent (e. g., a combination of an alcohol and an acid utilized to tack and activate preform solder, or even a single component like an alcohol, an ester, or an aldehyde) to generate a soldering paste that has an intrinsic generation (for example upon heating during the soldering process) of a reducing agent (e. g., an organic acid) to reduce the oxides on the materials involved without a utilization of hazardous materials.

In various embodiments, the solder material may either consist only of (or may essentially consist of) the metal particles, and the reducing agent may be provided via the atmosphere during the soldering process, or the solder material may be a mixture of a metal powder (solder powder, e. g., metal solder particles) and a chemical or mixture of chemicals that may be used to generate the reducing agent (e. g., an organic acid, for example formic acid) in the process. The liquid material included in the solder material in accordance with various embodiments may, in its initial state and during the soldering process, keep the solder material in place (“tacking” function), and may additionally, before it evaporates, reduce oxides on outer surfaces of the metal particles and/or metal surfaces to be joined, and may therefore also be referred to as a “reducing tacking agent”.

In various more specific embodiments, a combination of a bi-modal size distribution of high-melting metal solder particles with a least one type of low-melting metal solder particles and a mixture consisting of an alcohol selected from a specific group of alcohols (as specified below) and a carboxylic acid may be provided.

In various yet more specific embodiments, the solder material may include or consist of a powder mixture consisting of a bi-modal Ni particle size distribution with a Sn-based solder alloy and a combination of oxalic acid and glycerol.

The reducing agent may be able to activate a passivated metal surface (e.g. the metal surfaces to be joined and/or surfaces of metal solder particles included in the solder material) at least during the soldering process. This may typically mean that the reducing agent is able to reduce (and thereby possibly remove) oxide layers from the surfaces to be joined by the solder (the bonding surfaces) and/or from the solder particles to allow good bonding.

In various embodiments, a solder material (e.g., a solder paste) is provided that includes metal solder particles (sometimes referred to simply as metal particles or particles), and a reducing agent that is capable of reacting chemically with a metal oxide, e.g. of reducing a metal oxide that may have formed on the metal solder particles, during the soldering process.

The activation/reduction that occurs during the soldering process may be due to the temperature achieved during the soldering. A maximum temperature during the soldering may be in a range from about 250° C. to about 400° C.

The solder material may in various embodiments be free from lead. The solder particles and a liquid, in which the solder particles may be dispersed, may be free from lead.

The liquid, which may either consist of a certain type of alcohol or include or consist of a certain type of alcohol in combination with a carboxylic acid, may be configured to completely or essentially completely evaporate during the soldering process. In other words, the solder material in accordance with various embodiments is configured to form a residual-free or essentially residual-free solder layer.

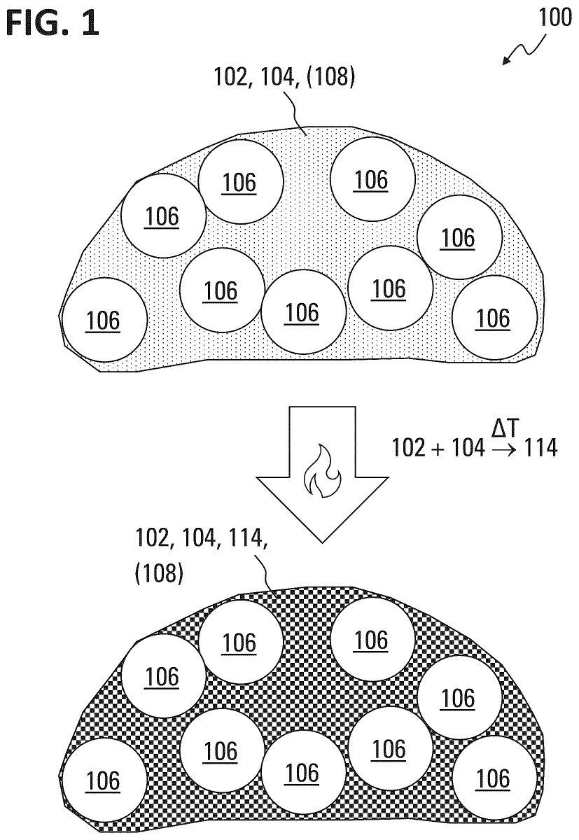

FIG. 1 shows a schematic illustration of a solder material 100 in accordance with various embodiments and visualizes its reaction to a soldering process.

The solder material 100 may include metal solder particles 106, also referred to as “solder particles”, for short.

In various embodiments, all the solder particles 106 may have approximately the same size. In various embodiments, the solder particles 106 may have different sizes, for example a bi-modal size distribution or the solder particles may have three, four or more size groups. Sizes of the solder particles 106 may generally be in a range from about 1 μm to about 80 μm. In a case of a bi-modal size distribution, a first amount of particles may have sizes in a range from about 1 μm to about 20 μm, and a second amount of particles may have sizes in a range from about 30 μm to about 50 μm.

The solder particles 106 may in various embodiments all include or consist of the same material. In various embodiments, a material or materials that the solder particles include or consist of may differ. The materials may differ in connection with the size of the solder particles 106, and/or independent from the solder particle size. For example, a first group of solder particles 106 may include or consist of a first material, and a second group of solder particles 106 may include or consist of a second material. In various embodiments, the first group of solder particles 106 may have a first particle size, and the second group of solder particles 106 may have a second particle size. The first and second particle size may be the same or different (bi-modal size distribution). In other embodiments, the first group of solder particles 106 may have two or more sizes, and/or the second group of solder particles 106 may have two or more sizes. Said sizes of the first and second group of solder particles 106 may be the same and/or different. In a bi-modal size distribution, a first amount of particles may optionally have sizes in a range from about 1 μm to about 20 μm, and a second amount of particles may optionally have sizes in a range from about 30 μm to about 50 μm. It is noted that, depending on a formation and/or selection process of the solder particles 106 that are supposed to have a certain predefined size, the “particle size” is actually rather a size distribution or a range of sizes.

The metal solder particles include low-melting metal solder particles 106 with a first melting temperature and high-melting metal solder particles 106 with a second melting temperature, wherein the first melting temperature is lower than the second melting temperature.

The low-melting metal solder particles 106 may optionally include or consist of at least one metal selected from the group consisting of Bi, Sn, Ga, Ge, Zn, and In (also referred to herein as low-melting materials). The metal solder particles 106 may for example include tin.

The high-melting metal solder particles 106 may include or consist of at least one metal selected from the group consisting of Ni, Cu, Ag, Au, Pt, and Pd (also referred to herein as high-melting materials).

The terms “low-melting” and “high-melting” as used herein may be understood as relative terms with respect to each other. In other words, the low-melting solder particles 106 may have a lower melting point than the high-melting particles 106.

The metal solder particles 106 may for example include at least 30 wt % nickel based on the total weight of the metal solder particles, or of any of the other above specified high-melting materials. The low-melting metal solder particles 106 may for example include or consist of tin.

In various embodiments, the solder material may be configured for a soldering temperature of between about 200° C. and about 450° C.

The solder material 100 may include a carboxylic acid 102. Preferably the carboxylic acid is a dicarboxylic acid.

The solder material 100 may further include an alcohol 104 selected from the group consisting of methanol, ethanol, propan-1-ol, propan-2-ol, ethylene glycol (ethane-1,2-diol), ethanolamine (2-aminoethanol), 2-methyl-1-propanol, butan-1-ol, pentan-1-ol, 1,2-propanediol, 1,3-propanediol, and glycerol.

The carboxylic acid 102 may react with the alcohol 104 to form a reducing agent 114 when heated as part of a soldering process.

In other words, when the solder material 100 is heated up to a maximum temperature of between about 200° C. and about 450° C., the carboxylid acid 102 and the alcohol 104 may react to form the reducing agent 114, which may not have been present in the solder material 100 before. The reaction may take place (e. g., well) before the maximum soldering temperature (e. g., as specified above) is reached, in particular before an evaporation temperature of the carboxylic acid 102 or an evaporation temperature of the alcohol 104, which is lower than the maximum soldering temperature, is reached.

The carboxylic acid 102 may have the formula CₙH₂ₙ₋₂Oₓ, wherein n may be 2 to 10, and x may be 4 to 7.

The carboxylic acid 102 may be selected from linear or branched, substituted or unsubstituted C₂₋₁₀ di- or tricaboxylic acids, for example from linear or branched, substituted or unsubstituted C₂₋₆ di- or tricaboxylic acids, for example from linear or branched, substituted or unsubstituted C₂₋₆ di- or tricaboxylic acids.

The carboxylic acid 102 may be selected from linear substituted or unsubstituted C₂₋₁₀ di- or tricaboxylic acids, for example from linear substituted or unsubstituted C₂₋₆ di- or tricaboxylic acids, for example from linear substituted or unsubstituted C₂₋₆ di- or tricaboxylic acids.

The carboxylic acid may be selected from linear, unsubstituted C₂₋₁₀ di- or tricaboxylic acids, preferably from linear, unsubstituted C2-6 di- or tricaboxylic acids, most preferably from linear, substituted C₂₋₆ di- or tricaboxylic acids.

The carboxylic acid may be selected from linear, unsubstituted C₂₋₁₀ dicaboxylic acids, preferably from linear, unsubstituted C₂₋₆ dicaboxylic acids, most preferably from linear, substituted C₂₋₆ dicaboxylic acids.

The carboxylic acid 102 may for example be selected from the group consisting of caproic acid (hexanoic acid), enanthic acid (heptanoic acid), caprylic acid (octanoic acid), pelargonic acid (nonanoic acid), capric acid (decanoic acid), phenyl-acetic acid, benzoic acid, salicylic acid, aminobenzoic acid, 4-n-butylbenzoic acid, 4-t-butylbenzoic acid, 3,4-dimethoxybenzoic acid, oxalic acid, succinic acid, glutaric acid, succinic acid, maleic acid, fumaric acid, malic acid, adipic acid, citric acid, ascorbic acid, and malonic acid.

Optionally, the carboxylic acid 102 may for example be selected from the group consisting of oxalic acid, succinic acid, glutaric acid, succinic acid, maleic acid, fumaric acid, malic acid, adipic acid, citric acid, ascorbic acid, and malonic acid.

Optionally, the carboxylic acid 102 may form 0.5 to 1.0 wt % of the solder material 100.

In various embodiments, the alcohol 104 may in particular be selected from the group consisting of ethylene glycol (ethane-1,2-diol), ethanolamine (2-aminoethanol), 2-methyl-1-propanol, butan-1-ol, pentan-1-ol, 1,2-propanediol, 1,3-propanediol, and glycerol.

A mixing ratio by weight of alcohol:acid may be in a range from 5:1 to 100:1.

The carboxylic acid 102 and the alcohol 104 may together form 5 to 50 wt % of the solder material 100.

The solder material 100 may in various embodiments be free or essentially free from solvent 108, other than the alcohol 104.

In various embodiments, the solder material 100 may optionally further include a solvent 108. The solvent 108 may be configured to adjust a viscosity of the solder material 100 in order to make it suitable for an intended dispensing process, for example for forming a printable paste. The combination of the carboxylic acid 102 and the alcohol 104, on the other hand, may in various embodiments also be referred to as “tacking agent” due to their combined adhesive properties that help to keep the solder material 100 in place before the soldering process.

The solvent 108 may be a polar solvent or an unpolar solvent, for example selected from the group consisting of water, toluene, diethylene, glycol, triethylene glycol, triethylene glycol dimethyl ether, ethylene glycol, dibutyl ether, Γ-Butyrolacton, propylene carbonate, isopropanol, diethylene glycol monoethyl ether, and diethylene glycol monobutyl ether acetate.

The alcohol 104 and the solvent 108 may have a mixing ratio by weight (alcohol:solvent) in a range from 99:1 to 1:99, optionally between 80:1 and 1:80.

In an exemplary embodiment, the alcohol 104 may be glycerin, the solvent 108 may be propylene glycol, and, optionally, the mixing ratio by weight (alcohol:solvent) may be 20:80 wt %.

In an exemplary embodiment, the alcohol 104 may be glycerin, the solvent 108 may be water, and, optionally, the mixing ratio by weight (alcohol:solvent) may be 80:20 wt %.

The carboxylic acid 102 and the sum of alcohol 104 and the optional solvent 108 may have a mixing ratio by weight ((sum of alcohol and solvent):acid) in a range from 5:1 to 100:1, optionally between 10:1 and 30:1, further optionally around 20:1.

The solder material 100 may include or consist of any of the following combinations:

TABLE 1

| | List of | List of | |
|---|---|---|---|
| List of | potential | corresponding | List of |
| potential | dicarboxylic | reducing | potential |
| alcohols | acids | acids | solvents |
| glycerol | oxalic acid | formic acid | H₂O |
| ethylene glycol | malonic acid | acetic acid | isopropanol |
| ethanolamine | succinic acid | 2-propanoic acid | diethylene glycol |
| 1,2-propanediol | glutaric | butanoic acid | triethylene glycol |
| 1,3-propanediol | adipic acid | pentanoic acid | triethylene glycol |
| | | | dimethyl ether |
| | citric acid | formic acid | ethylene glycol |
| | ascorbic acid, | | dibutyl ether |
| | | | Γ-butyrolacton |
| | | | propylene |
| | | | carbonate |

The above Table 1 is meant to be understood as follows:

Any of the alcohols 104 of the first column may be combined with the carboxylic acid 102 of the second column of the same row.

The alcohol 104 and the carboxylic acid 102 may, upon heating during the soldering process, form the reducing agent 114 (e. g., an acid) as listed in the same row of the third column.

Thus, the solder material 100 may include or consist of oxalic acid and glycerol for forming formic acid, or the solder material 100 may include or consist of malonic acid and ethylene glycol for forming acetic acid, or the solder material 100 may include or consist of ethanolamine and succinic acid for forming 2-propanoic acid, or the solder material 100 may include or consist of 1,2-propanediol and glutaric acid for forming butanoic acid, or the solder material 100 may include or consist of 1,3 propanediol and adipic acid for forming pentanoic acid, or the solder material 100 may include or consist of methanol and citric acid for forming formic acid.

Any of those combinations may optionally be combined with any of the solvents 108 listed in the fourth column. This skilled person is able to select a suitable solvent 108 based on a given application. In other words, the fourth column listing the solvents 108 may not follow the row-wise matching pattern of the first three columns. This is indicated by the double-line separation of the fourth column.

For example, the combination of glycerol and oxalic acid may optionally be combined with any of the solvents 108 listed in the fourth column, as suitable for an intended application.

The solder material 100 may include or consist of oxalic acid and glycerol. The oxalic acid may react with the glycerol to generate formic acid in situ when heated as part of the soldering process.

TABLE 2

| List of potential | List of potential | List of potential |
|---|---|---|
| alcohols | dicarboxylic acids | solvents |
| glycerol | oxalic acid | H₂O |
| ethylene glycol | malonic acid | isopropanol |
| ethanolamine (2- | succinic acid | diethylene glycol |
| aminoethanol) | | |
| 1,2-propanediol | glutaric | triethylene glycol |
| 1,3-propanediol | adipic acid | triethylene glycol |
| | | dimethyl ether |
| methanol | citric acid | ethylene glycol |
| ethanol | ascorbic acid | dibutyl ether |
| propan-1-ol | | Γ-butyrolacton |
| propan-2-ol | | propylene |
| | | carbonate |
| 2-methyl-1-propanol | | |
| butan-1-ol | | |
| pentan-1-ol | | |
| diethylene glycol | | |
| diethylene glycol | | |
| monoethyl ether | | |
| dipropylene glycol | | |
| monoethyl ether | | |
| 3-amino-1,2- | | |
| propanediol | | |
| isopropylidenglycerin | | |
| ethanolamine | | |

The above Table 2 is meant to be understood as follows:

Any of the alcohols 104 of the first column may be combined with any of the carboxylic acids 102 of the second column, and optionally with any of the solvents 108 of the third column. That the table entries are to be understood as independent lists, instead of row-by-row, is indicated by the double line between the columns.

In various embodiments, a weight ratio of the metal solder particles 106 based on a total sum of the metal solder particles 106, the carboxylic acid 102 and the alcohol 104 (and, optionally, the solvent 108) is at least 80%.

In various embodiments, the solder material 100 may consist of or essentially consist of the metal solder particles 106, the carboxylid acid 102, and the alcohol 104.

The solder material 100 may in various embodiments be configured as a solder paste, with or without the solvent 108.

In various embodiments, the carboxylic acid 102 is a dicarboxylic acid.

A ratio of alcohol:(carboxylic acid) may be in a range from about 5:1 to 100:1, for example in a range from 10:1 to 40:1, for example in a range from about 15:1 to 30:1, for example 20:1.

In various embodiments, the solder material 100 may include a solvent 108 to adjust the viscosity of the mixture to the desired application.

The solder material 100 may for example include a solvent 108 in an amount of up to, for example, 15 wt. %, preferably up to 5 wt. %.

A content of alcohol and carboxylic acid may be in a range from about 5 to about 20 wt. % of the solder material 100, preferably in a range from about 11 to about 16 wt. %

A ratio of (alcohol and solvent):acid may be in a range from about 5:1 to about 100:1, for example in a range from about 10:1 to about 40:1, for example in a range from about 15:1 to 30:1, for example 20:1

As already mentioned above, the soldering temperature for which the solder material 100 may be configured may in various embodiments be between about 200° C. and about 450° C. At the soldering temperature, at least some of the solder particles 106 may melt, for example all the solder particles 106 or, for example, between 20 wt % and 100 wt % of the solder particles 106.

Upon heating, before and/or during the melting of the solder particles 106, the carboxylic acid 102 and the alcohol 104 may react to form the reducing agent 114 and reduce oxides that may be present on the solder particles 106 (and/or elsewhere in the solder material) and/or on the surfaces to be joined by the soldering process.

In various embodiments, the alcohol 104 and the carboxylic acid 102 (and optionally, the solvent 108) may have an evaporation temperature below the soldering temperature for which the lead-free solder material is configured. In other words, more than 95 wt %, preferably more than 98 wt. %, more preferably about 99 wt % and most preferably all of the alcohol 104 and the carboxylic acid 102 (and optionally, the solvent 108) may evaporate during the soldering process. The same applies to the reducing agent which may be formed in situ in the soldering process. Thus, essentially only the material provided by the solder particles 106 may remain to form the connection between the joined surfaces, and the alcohol 104 and the carboxylic acid (and optionally, the solvent 108) may leave essentially no residue. In other words, the solder material 100 may be configured as a “no-clean” solder material 100, e. g., solder paste

As described above, the solder material 100 may be used for joining at least two (metal) surfaces.

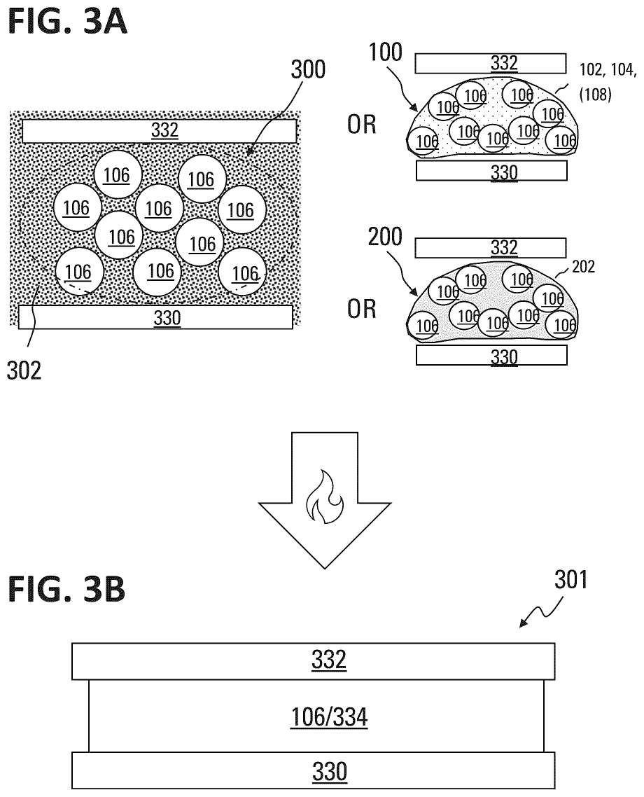

Thus, in various embodiments, a layer structure 301 may be formed using the solder material 100. FIG. 3B illustrates various embodiments of such a layer structure 301.

The layer structure 301 may include a first metal layer 330, a second metal layer 332, and a solder layer 334 formed by soldering the first metal layer 330 to the second metal layer 332 using the solder material 100 as described above (or the solder material 200 that will be described below). Since the solder layer 334 consists of or essentially consists of only the solder particles 106, the reference sign 106 is provided together with the reference sign 334 for the solder layer.

The soldering process may include heating (using a heat source) at least the solder material 100 to a predefined soldering temperature. Typically, at least one of the first metal layer 330 and the second metal layer 332 may be heated, too.

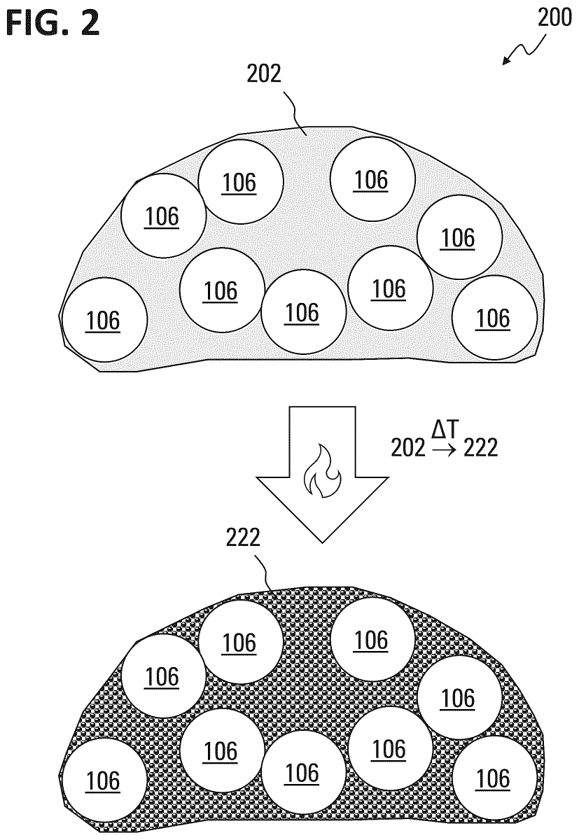

FIG. 2 shows a schematic illustration of a solder material 200 in accordance with various embodiments and visualizes its reaction to the soldering process.

As described above, in various embodiments, a solder material may consist of metal particles and a reducing tacking agent that may be formed by a single component to generate a soldering paste to reduce the oxides on the materials involved upon heating during the soldering process.

The solder material 200 may consist of metal solder particles 106, for example as described above for the metal particles 106 of the solder material 100, and a single component 202 that may be either one of an alcohol, an ester, or an aldehyde.

In the case of the single component being formed by the alcohol, the alcohol may be a linear or branched, substituted or unsubstituted alcohol of alkanes or alkenes including 1 to 20 carbon atoms. In other words, the alcohol may be selected from a group of alcohols, the group consisting of linear alcohols of alkanes or alkenes including 1 to 20 carbon atoms, branched alcohols of alkanes or alkenes including 1 to 20 carbon atoms, substituted alcohols of alkanes or alkenes including 1 to 20 carbon atoms, and unsubstituted alcohols of alkanes or alkenes including 1 to 20 carbon atoms.

The alcohol may for example include 1 to 10 carbon atoms, for example 2 to 6 carbon atoms, for example 3 to 5 carbon atoms.

The alcohol may for example be at least one alcohol, for example at least one alcohol with a boiling point above 100° C., for example above 130° C. for example 150° C., and below a melting point of the solder particles 106.

The alcohol may be selected from the group consisting of methanol, ethanol, propan-1-ol, propan-2-ol, 2-methyl-1-propanol, butan-1-ol, pentan-1-ol, 1-hexanol, 1-heptanol, 1-octanol.

In the case of the single component being formed by the ester, the ester may have the general formula:

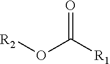

wherein R1 and R2 are, independently of each other, selected from linear or branched, saturated or unsaturated, substituted or unsubstituted hydrocarbon groups including 1 to 20 carbon atoms.

The single component may for example be octyl acetate.

In the case of the single component being formed by the aldehyde, the aldehyde may be selected from linear or branched, substituted or unsubstituted aldehydes of alkanes or alkenes including up to 20 carbon atoms and 1 to 6 heteroatoms selected from O, S, and N, substituted or unsubstituted aldehydes of cycloalkyls, cycloalkenyls or aryls including up to 20, preferably up to 12 carbon atoms, substituted or unsubstituted aldehydes of heterocycloalkyls, heterocycloalkenyls or heteroaryls including up to 20 carbon atoms, and 1 to 6 heteroatoms selected from O, S, and N, linear or branched, substituted or unsubstituted aldehydes of alkylcycloalkyls, alkenylcycloalkyls, alkylcycloalkenyls, alkenylcycloalkenyls, alkylarysl or alkenylaryls including up to 20 carbon atoms, linear or branched, substituted or unsubstituted aldehydes of heteroalkylcycloalkyls, heteroalkenylcycloalkyls, heteroalkylcycloalkenyls, heteroalkenylcycloalkenyls, heteroalkylaryls or heteroalkenylaryls including up to 20 carbon atoms, and 1 to 6 heteroatoms selected from O, S, and N, and linear or branched, substituted or unsubstituted aldehydes of heteroalkylheterocycloalkyls, heteroalkenylheterocycloalkyls, heteroalkylheterocycloalkenyls, heteroalkenylheterocycloalkenyls, heteroalkylheteroaryls or heteroalkenylheteroaryls including up to 20 carbon atoms, and 1 to 6 heteroatoms selected from O, S, and N.

The aldehyde may optionally be selected from the group consisting of glutaraldehyde, benzaldehyde, vanillin, furfural, hexanal, heptanal, octanal, nonanal, malondialdehyde, glutaraldehyde, cinnamaldehyde, and glycolaldehyde.

In various embodiments, the alcohol, the ester, or the aldehyde, respectively, that is included in the solder material, may have an evaporation temperature below a soldering temperature for which the solder material is configured.

Regarding other aspects, like for example regarding a texture of the solder material 200, a residue-free evaporation, etc., the soldering process, the solder material 200 and the method of forming a layer structure 301 may be similar or identical to the solder material 100 described above.

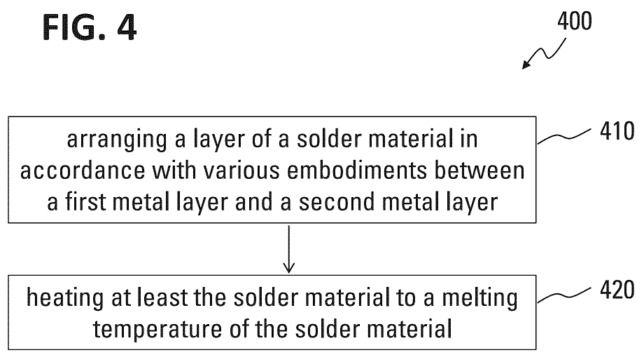

FIG. 4 shows a flow diagram 400 of a method of forming a layer structure in accordance with various embodiments.

The method may include arranging a layer of a solder material 100, 200 in accordance with various embodiments between a first metal layer 330 and a second metal layer 332 (in 410), and heating at least the solder material 100, 200 to a melting temperature of the solder material 100, 200 (in 420).

In various embodiments, the arranging of the layer of the solder material 100, 200 may for example include printing, arranging a paste using a mask and a squeegee, positioning a solid layer or tablet, and the like, for example as known in the art.

The heating may in various embodiments be performed essentially as known in the art, for example at soldering temperatures as described above. Often at least one of the first metal layer 330 and the second metal layer 332 may be heated to the melting temperature of the solder material 100, 200, too.

FIG. 3A visualizes a method of forming a layer structure, wherein the layer structure 301 is shown in FIG. 3B.

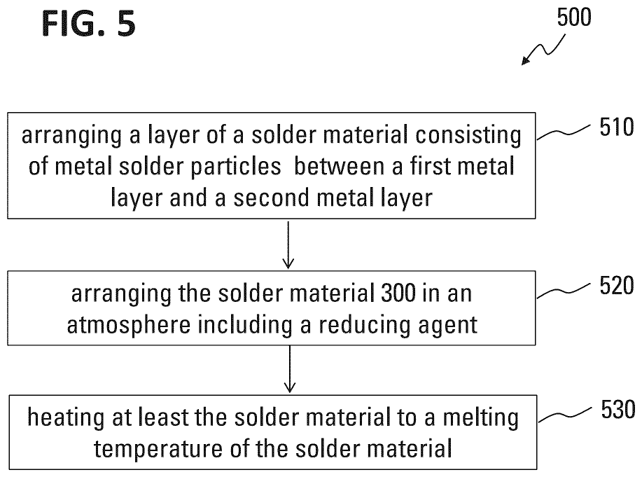

FIG. 5 is a flow diagram 500 of a method of forming a layer structure, for example as visualized in FIG. 3A.

The method may include arranging a layer of a solder material 300 consisting of metal solder particles 106 between a first metal layer 330 and a second metal layer 332.

The method may further include arranging the solder material 300 in an atmosphere including a reducing agent 302, and heating at least the solder material 300 to a melting temperature of the metal solder particles 106.

In other words, the solder material 300 may only be provided with the reducing agent 302 during the soldering process, and it may be sufficient that the solder material 300 consists only of the metal particles themselves.

The reducing agent 302 may for example be or include formic acid, acetic acid, 2-propanoic acid, butanoic acid, or pentanoic acid.

Optionally, the metal solder particles 106 may have properties as described above for the metal solder particles 106.

Various examples will be illustrated in the following:

Example 1 is a solder material. The solder material may include metal solder particles, a carboxylic acid, and an alcohol selected from the group consisting of methanol, ethanol, propan-1-ol, propan-2-ol, ethylene glycol (ethane-1,2-diol), ethanolamine (2-aminoethanol), 2-methyl-1-propanol, butan-1-ol, pentan-1-ol, 1,2-propanediol, 1,3-propanediol, and glycerol.

In Example 2, the subject-matter of Example 1 may optionally include that the carboxylic acid is configured to generate, in combination with the alcohol, a reducing agent when heated as part of a soldering process.

In Example 3, the subject-matter of Example 2 may optionally include that the carboxylic acid has the formula CₙH₂ₙ₋₂Oₓ, wherein n=2 to 10, and x=4 to 7.

In Example 4, the subject-matter of Example 2 or 3 may optionally include that the carboxylic acid is selected from the group consisting of caproic acid (hexanoic acid), enanthic acid (heptanoic acid), caprylic acid (octanoic acid), pelargonic acid (nonanoic acid), capric acid (decanoic acid), phenyl-acetic acid, benzoic acid, salicylic acid, aminobenzoic acid, 4-n-butylbenzoic acid, 4-t-butylbenzoic acid, 3,4-dimethoxybenzoic acid, oxalic acid, succinic acid, glutaric acid, succinic acid, maleic acid, fumaric acid, malic acid, adipic acid, citric acid, ascorbic acid, and malonic acid.

In Example 5, the subject-matter of any of Examples 2 to 4 may optionally include that the carboxylic acid forms 0.5 to 1.0 wt % of the solder material.

In Example 6, the subject-matter of any of Examples 1 to 5 may optionally include that the alcohol is selected from the group consisting of ethylene glycol (ethane-1,2-diol), ethanolamine (2-aminoethanol), 2-methyl-1-propanol, butan-1-ol, pentan-1-ol, 1,2-propanediol, 1,3-propanediol, and glycerol.

In Example 7, the subject-matter of any of Examples 1 to 6 may optionally include that a mixing ratio by weight of alcohol:acid is in a range from 5:1 to 100:1.

In Example 8, the subject-matter of any of Examples 1 to 7 may optionally include that the carboxylic acid and the alcohol together form 5 to 50 wt % of the solder material.

In Example 9, the subject-matter of any of Examples 1 to 8 may optionally further include a solvent.

In Example 10, the subject-matter of Example 9 may optionally include that the solvent is a polar solvent or an unpolar solvent.

In Example 11, the subject-matter of Example 9 or 10 may optionally include that the solvent is selected from the group consisting of water, toluene, diethylene, glycol, triethylene glycol, triethylene glycol dimethyl ether, ethylene glycol, dibutyl ether, Γ-Butyrolacton, propylene carbonate, isopropanol, diethylene glycol monoethyl ether, and diethylene glycol monobutyl ether acetate.

In Example 12, the subject-matter of any of Examples 9 to 11 may optionally include that the alcohol and the solvent have a mixing ratio by weight (alcohol:solvent) in a range from 99:1 to 1:99, optionally between 80:1 and 1:80.

In Example 12a, the subject-matter of any of Examples 9 to 12 may optionally include that the alcohol is glycerin, the solvent is propylene glycol, and, optionally, the mixing ratio by weight (alcohol:solvent) is 20:80 wt %.

In Example 12b, the subject-matter of any of Examples 9 to 12 may optionally include that the alcohol is glycerin, the solvent is water, and, optionally, the mixing ratio by weight (alcohol:solvent) is 80:20 wt %.

In Example 13, the subject-matter of any of Examples 9 to 12 may optionally include that the carboxylic acid and the sum of alcohol and solvent have a mixing ratio by weight ((sum of alcohol and solvent):acid) in a range from 5:1 to 100:1, optionally between 10:1 and 30:1, further optionally around 20:1.

In Example 14, the subject-matter of any of Examples 1 to 13 may optionally include or consist of one of a group of combinations, the group consisting of oxalic acid and glycerol, malonic acid and ethylene glycol, ethanolamine and succinic acid, 1,2-propanediol and glutaric acid, 1,3 propanediol and adipic acid, and methanol and citric acid.

In Example 15, the subject-matter of any of Examples 1 to 14 may optionally include or consist of oxalic acid and glycerol.

In Example 16, the subject-matter of Example 15 may optionally include that the oxalic acid is configured to generate, in combination with the glycerol, formic acid when heated as part of a soldering process.

In Example 17, the subject-matter of any of Examples 1 to 16 may optionally include that a weight ratio of metal solder particles based on a total sum of the metal solder particles, the carboxylic acid and the alcohol is at least 80%.

In Example 18, the subject-matter of any of Examples 1 to 17 may optionally include that the solder material is configured as a solder paste.

In Example 19, the subject-matter of any of Examples 1 to 18 may optionally include that the carboxylic acid and the alcohol have evaporation temperatures below a soldering temperature for which the solder material is configured.

In Example 20, the subject-matter of any of Examples 1 to 19 may optionally include that the solder material consists of or essentially consists of the metal solder particles 106, the carboxylid acid and the alcohol.

In Example 21, the subject-matter of any of Examples 1 to 20 may optionally include that the carboxylic acid is a dicarboxylic acid.

Example 22 is a solder material. The solder material may consist of metal solder particles and a single component that is either one of an alcohol, an ester, or an aldehyde.

In Example 23, the subject-matter of Example 22 may optionally include that the alcohol is a linear or branched, substituted or unsubstituted alcohol of alkanes or alkenes including 1 to 20 carbon atoms.

In Example 24, the subject-matter of Example 22 or 23 may optionally include that the alcohol is selected from the group consisting of methanol, ethanol, propan-1-ol, propan-2-ol, 2-methyl-1-propanol, butan-1-ol, pentan-1-ol, 1-hexanol, 1-heptanol, 1-octanol.

In Example 25, the subject-matter of Example 24 may optionally include that the ester has the general formula

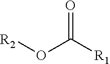

wherein R1 and R2 are, independently of each other, selected from linear or branched, saturated or unsaturated, substituted or unsubstituted hydrocarbon groups including 1 to 20 carbon atoms.

In Example 26, the subject-matter of Example 22 or 25 may optionally include that the single component is octyl acetate.

In Example 27, the subject-matter of Example 22 may optionally include that the aldehyde is selected from linear or branched, substituted or unsubstituted aldehydes of alkanes or alkenes including up to 20 carbon atoms and 1 to 6 heteroatoms selected from O, S, and N, substituted or unsubstituted aldehydes of cycloalkyls, cycloalkenyls or aryls including up to 20, preferably up to 12 carbon atoms, substituted or unsubstituted aldehydes of heterocycloalkyls, heterocycloalkenyls or heteroaryls including up to 20 carbon atoms, and 1 to 6 heteroatoms selected from O, S, and N, linear or branched, substituted or unsubstituted aldehydes of alkylcycloalkyls, alkenylcycloalkyls, alkylcycloalkenyls, alkenylcycloalkenyls, alkylarysl or alkenylaryls including up to 20 carbon atoms, linear or branched, substituted or unsubstituted aldehydes of heteroalkylcycloalkyls, heteroalkenylcycloalkyls, heteroalkylcycloalkenyls, heteroalkenylcycloalkenyls, heteroalkylaryls or heteroalkenylaryls including up to 20 carbon atoms, and 1 to 6 heteroatoms selected from O, S, and N, and linear or branched, substituted or unsubstituted aldehydes of heteroalkylheterocycloalkyls, heteroalkenylheterocycloalkyls, heteroalkylheterocycloalkenyls, heteroalkenylheterocycloalkenyls, heteroalkylheteroaryls or heteroalkenylheteroaryls including up to 20 carbon atoms, and 1 to 6 heteroatoms selected from O, S, and N.

In Example 28, the subject-matter of Example 22 or 27 may optionally include that the aldehyde is selected from the group consisting of glutaraldehyde, benzaldehyde, vanillin, furfural, hexanal, heptanal, octanal, nonanal, malondialdehyde, glutaraldehyde, cinnamaldehyde, and glycolaldehyde.

In Example 29, the subject-matter of any of Examples 22 to 28 may optionally include that the alcohol, the ester, or the aldehyde, respectively, that is included in the solder material has an evaporation temperature below a soldering temperature for which the solder material is configured.

In Example 30, the subject-matter of any of Examples 1 to 29 may optionally include that the metal solder particles have a bimodal size distribution, for example with a first amount of particles having sizes in a range from about 1 μm to about 20 μm, and with a second amount of particles having a size in a range from about 30 μm to about 50 μm.

In Example 31, the subject-matter of any of Examples 1 to 30 may optionally include that the metal solder particles include low-melting metal solder particles with a first melting temperature and high-melting metal solder particles with a second melting temperature, wherein the first melting temperature is lower than the second melting temperature.

In Example 32, the subject-matter of Example 31 may optionally include that the low-melting metal solder particles include or consist of at least one metal selected from the group consisting of Bi, Sn, Ga, Ge, Zn, and In.

In Example 33, the subject-matter of Example 31 or 32 may optionally include that the high-melting metal solder particles include or consist of at least one metal selected from the group consisting of Ni, Cu, Ag, Au, Pt, and Pd.

In Example 34, the subject-matter of any of Examples 1 to 33 may optionally include that the metal solder particles include at least 30 wt % nickel based on the total weight of the metal solder particles.

In Example 35, the subject-matter of any of Examples 1 to 33 may optionally include that the metal solder particles include tin.

In Example 36, the subject-matter of any of Examples 1 to 35 may optionally include that the solder material is configured for a soldering temperature of between about 200° C. and about 450° C.

Example 37 is a layer structure. The layer structure may include a first metal layer, a second metal layer, and a solder layer formed by soldering the first metal layer to the second metal layer using the solder material of any of Examples 1 to 36.

Example 38 is a method of forming a layer structure. The method may include arranging a layer of solder material in accordance with any of Examples 1 to 36 between a first metal layer and a second metal layer, and heating at least the solder material to a melting temperature of at least a portion of the metal solder particles of the solder material.

Example 39 is a method of forming a layer structure. The method may include arranging a layer of a solder material consisting of metal solder particles between a first metal layer and a second metal layer, arranging the solder material in an atmosphere including a reducing agent, and heating at least the solder material to a melting temperature of at least a portion of the metal solder particles.

In Example 40, the subject-matter of Example 39 may optionally include that the metal solder particles have a bimodal size distribution, for example with a first amount of particles having sizes in a range from about 1 μm to about 20 μm, and with a second amount of particles having a size in a range from about 30 μm to about 50 μm.

In Example 41, the subject-matter of Example 39 or 40 may optionally include that the metal solder particles include low-melting metal solder particles with a first melting temperature and high-melting metal solder particles with a second melting temperature, wherein the first melting temperature is lower than the second melting temperature.

In Example 42, the subject-matter of Example 41 may optionally include that the low-melting metal solder particles include or consist of at least one metal selected from the group consisting of Bi, Sn, Ga, Ge, Zn, and In.

In Example 43, the subject-matter of Example 41 or 42 may optionally include that the high-melting metal solder particles include or consist of at least one metal selected from the group consisting of Ni, Cu, Ag, Au, Pt, and Pd.

In Example 44, the subject-matter of Example 39 to 43 may optionally include that the metal solder particles include at least 30 wt % nickel.

In Example 45, the subject-matter of Example 39 to 44 may optionally include that the metal solder particles include tin.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A solder material, comprising:
metal solder particles;
a carboxylic acid; and
an alcohol selected from the group consisting of:
methanol;
ethanol;
propan-1-ol;
propan-2-ol;
ethylene glycol (ethane-1,2-diol);
ethanolamine (2-aminoethanol);
2-methyl-1-propanol;
butan-1-ol;
pentan-1-ol;
1,2-propanediol;
1,3-propanediol; and
glycerol.

2. The solder material of claim 1,
wherein the carboxylic acid is configured to generate, in combination with the alcohol, a reducing agent when heated as part of a soldering process.

3. The solder material of claim 2,
wherein the carboxylic acid has the formula:
CₙH₂ₙ₋₂Oₓ
wherein:
n=2 to 10
x=4 to 7.

4. The lead-free solder material of claim 2, wherein
the carboxylic acid is selected from the group consisting of:
caproic acid (hexanoic acid),
enanthic acid (heptanoic acid)
caprylic acid (octanoic acid)
pelargonic acid (nonanoic acid)
capric acid (decanoic acid),
phenyl-acetic acid,
benzoic acid,
salicylic acid,
aminobenzoic acid,
4-n-butylbenzoic acid,
4-t-butylbenzoic acid,
3,4-dimethoxybenzoic acid,
oxalic acid,
succinic acid,
glutaric acid,
succinic acid,
maleic acid,
fumaric acid,
malic acid,
adipic acid,
ascorbic acid,
citric acid, and
malonic acid.

5. The solder material of claim 2,
wherein the carboxylic acid forms 0.5 to 1.0 wt % of the lead-free solder material.

6. The lead-free solder material of claim 1,
wherein the alcohol is selected from the group consisting of:
ethylene glycol (ethane-1,2-diol);
ethanolamine (2-aminoethanol);
2-methyl-1-propanol;
butan-1-ol;
pentan-1-ol;
1,2-propanediol;
1,3-propanediol; and
glycerol.

7. The lead-free solder material of claim 1,
wherein a mixing ratio by weight of alcohol:acid is in a range from 5:1 to 100:1.

8. The lead-free solder material of claim 1,
wherein the carboxylic acid and the alcohol together form 5 to 50 wt % of the lead-free solder material.

9. The lead-free solder material of claim 1, further comprising a solvent.

10. The lead-free solder material of claim 9, wherein the solvent is a polar solvent or an unpolar solvent.

11. The lead-free solder material of claim 9, wherein the solvent is selected from the group consisting of:
water;
toluene;
diethylene glycol;
triethylene glycol;
triethylene glycol dimethyl ether;
ethylene glycol;
dibutyl ether;
Γ-Butyrolacton;
propylene carbonate;
isopropanol;
diethylene glycol monoethyl ether; and
diethylene glycol monobutyl ether acetate.

12. The lead-free solder material of claim 9, wherein the alcohol and the solvent have a mixing ratio by weight (alcohol:solvent) in a range from 99:1 to 1:99, optionally between 80:1 and 1:80.

13. The lead-free solder material of claim 1, wherein the carboxylic acid and the sum of alcohol and solvent have a mixing ratio by weight ((sum of alcohol and solvent):acid) in a range from 5:1 to 100:1, optionally between 10:1 and 30:1, further optionally around 20:1.

14. The lead-free solder material of claim 1, comprising a group of combinations, the group consisting of:
oxalic acid and glycerol;
malonic acid and ethylene glycol;
ethanolamine and succinic acid;
1,2-propanediol and glutaric acid;
1,3 propanediol and adipic acid; and
methanol and citric acid.

15. The lead-free solder material of claim 1, comprising oxalic acid and glycerol.

16. The lead-free solder material of claim 15,
wherein the oxalic acid is configured to generate, in combination with the glycerol, formic acid when heated as part of a soldering process.

17. The lead-free solder material of claim 1,
wherein a weight ratio of metal particles based on a total sum of the metal particles, the carboxylic acid and the alcohol is at least 80%.

18. The lead-free solder material of claim 1,
configured as a solder paste.

19. The lead-free solder material of claim 1,
wherein the carboxylic acid and the alcohol have evaporation temperatures below a soldering temperature for which the lead-free solder material is configured.

20. The lead-free solder material of claim 1,
consisting of the metal solder particles, the carboxylic acid, and the alcohol.

21. The lead-free solder material of claim 1,
wherein the carboxylic acid is a dicarboxylic acid.

22. A lead-free solder material consisting of:
metal solder particles; and
a single component that is either one of an alcohol, an ester, or an aldehyde.

23. The lead-free solder material of claim 22,
wherein the alcohol is a linear or branched, substituted or unsubstituted alcohol of alkanes or alkenes including 1 to 20 carbon atoms.

24. The lead-free solder material of claim 22,
wherein the alcohol is selected from the group consisting of:
methanol;
ethanol;
propan-1-ol;
propan-2-ol;
2-methyl-1-propanol;
butan-1-ol;
pentan-1-ol;
1-hexanol;
1-heptanol;
1-octanol.

25. The lead-free solder material of claim 24,
wherein the ester has the general formula: 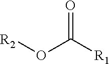
wherein
R1 and R2 are, independently of each other, selected from linear or branched, saturated or unsaturated, substituted or unsubstituted hydrocarbon groups including 1 to 20 carbon atoms.

26. The lead-free solder material of claim 22,
wherein the single component is octyl acetate.

27. The lead-free solder material of claim 22,
wherein the aldehyde is selected from:
linear or branched, substituted or unsubstituted aldehydes of alkanes or alkenes including up to 20 carbon atoms and 1 to 6 heteroatoms selected from O, S, and N;
substituted or unsubstituted aldehydes of cycloalkyls, cycloalkenyls or aryls including up to 20, preferably up to 12 carbon atoms;
substituted or unsubstituted aldehydes of heterocycloalkyls, heterocycloalkenyls or heteroaryls including up to 20 carbon atoms, and 1 to 6 heteroatoms selected from O, S, and N;
linear or branched, substituted or unsubstituted aldehydes of alkylcycloalkyls, alkenylcycloalkyls, alkylcycloalkenyls, alkenylcycloalkenyls, alkylarysl or alkenylaryls including up to 20 carbon atoms;
linear or branched, substituted or unsubstituted aldehydes of heteroalkylcycloalkyls, heteroalkenylcycloalkyls, heteroalkylcycloalkenyls, heteroalkenylcycloalkenyls, heteroalkylaryls or heteroalkenylaryls including up to 20 carbon atoms, and 1 to 6 heteroatoms selected from O, S, and N; and
linear or branched, substituted or unsubstituted aldehydes of heteroalkylheterocycloalkyls, heteroalkenylheterocycloalkyls, heteroalkylheterocycloalkenyls, heteroalkenylheterocycloalkenyls, heteroalkylheteroaryls or heteroalkenylheteroaryls including up to 20 carbon atoms, and 1 to 6 heteroatoms selected from O, S, and N.

28. The lead-free solder material of claim 1,
wherein the metal particles comprise low-melting metal particles with a first melting temperature and high-melting metal particles with a second melting temperature, wherein the first melting temperature is lower than the second melting temperature.

29. A layer structure, comprising:
a first metal layer;
a second metal layer; and
a solder layer formed by soldering the first metal layer to the second metal layer using the lead-free solder material of any of claim 1.
